(19) United States
(12) Patent Application Publication
(10) Pub. No.: US 2006/0095386 A1
(43) Pub. Date: May 4, 2006

(54) System and method for trust management

(76) Inventors: Andrew D. Jun, Hackettstown, NJ (US); John-Luc Bakker, Flemington, NJ (US); Chit F. Chung, Marlboro, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/266,827

(22) Filed: Nov. 4, 2005

Related U.S. Application Data
(60) Provisional application No. 60/624,995, filed on Nov. 4, 2004.

(51) Int. Cl. G06Q 99/00

(52) U.S. Cl. 705/64

(57) ABSTRACT

Disclosed is a system and method for establishing communications between a first node and a second node to enable interaction to occur over a network. The first node has a pre-established trust relationship with a first supporting node and the second node has a pre-established trust relationship with a second supporting node. The system and method include establishing a trust relationship between the first node and the second node. The trust relationship is based on a trust relationship between the first supporting node and the second supporting node. The pre-established trust relationships may also be partial trust relationships.

This application claims the benefit of U.S. Provisional Application No. 60/624,995 filed Nov. 4, 2004, which is incorporated herein by reference.

### BACKGROUND OF THE INVENTION

The present invention relates generally to Internet security, and more particularly to trust establishment for communications over the Internet.

As the popularity of the Internet continues to grow, the number of services available over the Internet also expands. Real-time services such as video on demand (VOD), music on demand, and games are currently offered by a variety of service providers. Conversational services are also being offered, such as audio-video conferencing and video telephony. Web services are additionally being offered by service providers. A service provider often “publishes” the services that the service provider has available by posting or listing these services on a service provider's web page. Additional information about the service is also typically provided by the service provider, such as the price associated with accessing the service and the computing resources needed for the service.

To enable a consumer to purchase a service from a service provider, a peer-to-peer (PTP) arrangement is often used. The service consumer (e.g., an individual) uses a device (e.g., a desktop computer, personal digital assistant (PDA), laptop, or wireless telephone) to communicate over the Internet with a service provider to obtain the service. The service provider provides the service to the consumer, and the consumer pays for the service (e.g., by transmitting credit card information to the service provider).

As the transaction occurs over the Internet, security and trust issues arise for both the consumer and the service provider regarding the exchange of services and the payment for the services. In particular, the service provider is concerned with securing fund transfers from consumers while consumers are concerned with actually receiving the offered services in return for their payment.

Because the consumer does not “know” the service provider and because the service provider does not “know” the consumer, the parties may not trust each other to deliver the promised services/payment. Additional concerns associated with the on-line transaction include anonymity and privacy of the consumer's identity, protection against transaction fraud for the consumer, and protection against content piracy.

One way to establish trust between a consumer and a provider (i.e., a consumer operating a first node and a provider operating a second node) in a PTP network is by authenticating each node, authorizing each node to be able to communicate with the other node, and ensuring that the consumer and provider are each accountable for their promises. Specifically, the first node has to be authenticated to the second node so that the second node is sure that the first node is who he says he is. Each node also has to be authorized to communicate with the other node and held responsible for the communications. Then, each node has to gather enough information for the trustworthiness or reputability of the other node via various means, such as credit check or referral, to establish a trust relationship. Due to the diversity of trustworthiness information and the complexity of collecting and processing such information for each “unknown” node, establishing trust in a PTP manner is considered to be a technically difficult problem.

Another solution to establishing trust in an e-commerce transaction is with a centralized architecture. A single organization vouches for a smaller, less reputable organization perhaps by authorizing the smaller organization to use authenticity information provided by the larger organization (also referred to as an authority node). As an example, a larger organization can allow a smaller organization to show the larger organization's trademark embedded with authenticity information on the smaller organization's web site. If a user of a client computer uses his web browser to go to the smaller organization's web site, and sees the larger organization's trademark, the user will then likely trust the smaller organization. Thus, the user will likely feel comfortable doing business with the smaller organization because the user recognizes the larger organization's trademark on the web site. Although this particular example fails to provide the smaller organization with any mechanism to trust the user, trustworthiness information on users can also be provided by the central authority (i.e., the larger organization). While the introduction of a commonly trusted third party greatly reduces the technical difficulty in establishing trust, the centralized approach, on the other hand, suffers from the “market segmentation” problem. Spontaneous transactions across different authority domains (i.e., different authority nodes with consumers and providers) are prohibited as the architecture relies on a static relationship with a single server. Only pre-authorized transactions can be conducted across authority domains.

Thus, there remains a need to enable a trust relationship between a provider of a service and a consumer of the service while solving the above-mentioned trust management issues for unknown nodes.

### SUMMARY OF THE INVENTION

The above-identified security issues often occur because of the PTP relationship between parties to a transaction and because each party is unfamiliar with the other party. Enabling a transaction to occur between the parties over a network typically requires a pre-existing relationship between the two parties in order to establish enough trust to progress with the transaction.

In accordance with the present invention, a system and method establishes communications between a first node (e.g., a customer) and a second node (e.g., a service provider) to enable interaction over a network. The first node has a pre-established trust relationship with a first supporting node and the second node has a pre-established trust relationship with a second supporting node. The system and method establish a trust relationship between the first node and the second node based on a trust relationship between the first supporting node and the second supporting node.

The trust relationship between the first node and the second node can result in an e-commerce transaction. The establishing of the trust relationship between the first node and the second node further includes authenticating the first node and authorizing the first node to communicate with the second node. The establishing of the relationship between the first node and the second node further includes establishing the first supporting node as being responsible for communications made from the first node. The system and method further includes receiving a request from the first node to establish the trust relationship with the second node.

Further, the supporting relationships (i.e., the relationships between the first node and the first supporting node or between the second node and the second supporting node) may be based on partial trust. Partial trust as used herein refers to when one party does not trust another party completely but rather trusts the party only to a specified degree (e.g., a specified monetary amount). For example, a supporting node may only support a node up to a predetermined amount of money. This predetermined amount of money may be based on a variety of factors such as the node's reputation, the node's credit limit, etc.

These and other advantages of the invention will be apparent to those of ordinary skill in the art by reference to the following detailed description and the accompanying drawings.

### BRIEF DESCRIPTION OF THE DRAWINGS

FIG. 1 shows a high level block diagram of a dynamic trust architecture;

FIG. 2 shows a high level block diagram of a node of the dynamic trust architecture; and

FIG. 3 shows a more detailed block diagram of the dynamic trust architecture.

### DETAILED DESCRIPTION

Historically, trust has been established via face to face meetings, recommendations, reputation, letters of credit, and/or background checks. An organization may trust a person based on the person's reputation or past behavior. For example, an insurance company will likely provide insurance with a low premium to an individual with an excellent driving record. This trust is based on the individual's previous behavior.

During e-commerce transactions, however, new techniques are needed to appropriately establish trust between parties because the parties often do not have any relationship with each other. Instead of attempting to establish trust between a first party and a second party in a peer-to-peer or a centralized manner, the task of trust management is delegated from the first party and the second party to a first supporting party and a second supporting party that are already well-known in the market. The trust management delegations are based on pre-existing relationships between the first party and the first supporting party and between the second party and the second supporting party. With reputable names in the market, the two supporting parties can dynamically establish trust between each other more easily than in a PTP network, or they may already have existing relationships. Then, trust between the first party and the second party can result from those piece-wise trust relationships.

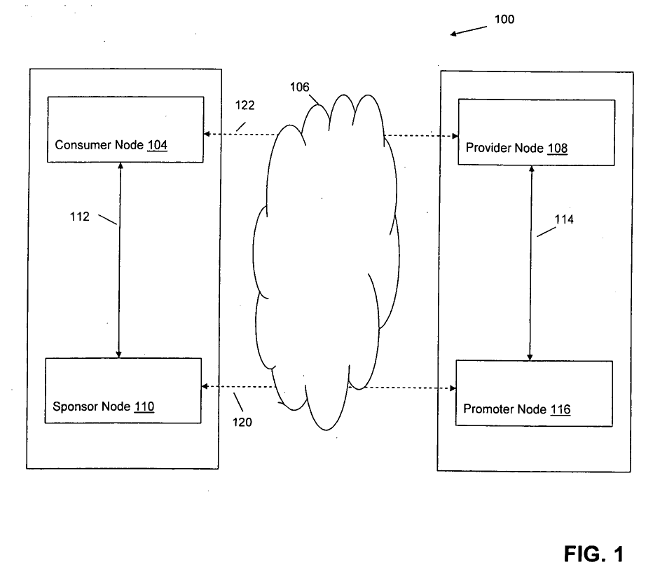

FIG. 1 shows a high level block diagram of a dynamic trust architecture 100. The dynamic trust architecture 100 includes a first node (also referred to below as a consumer node) 104 attempting to communicate over a network 106 with a second node (also referred to below as a provider node) 108. The consumer node 104 and the provider node 108 may each be a laptop, a PDA, a wireless device, a computer, etc. The network 106 may be any data network, such as the public Internet or private intranet.

The consumer can be a consumer of a product delivered by the provider node 108 or a service that the provider node 108 provides over the network 106. The consumer node 104 first establishes a relationship (shown with arrow 112) with a first supporting node (also referred to below as a sponsor node) 110. This relationship may be established via a contractual agreement to provide a specified level of service, typically involving a maximum allowed response time or guarantee of service being available for a minimum time, and terms and conditions for pricing, service quality, etc. Similarly, the provider node 108 establishes a relationship (shown with arrow 114) with a second supporting node (also referred to below as a promoter node) 116. In one embodiment, this relationship is also established via a contractual agreement between the promoter node 116 and the provider node 108. Each supporting node 110, 116 may be a computer (e.g., a server).

In one embodiment, the consumer node 104 has to pay a fee or perform a service to establish a relationship with the sponsor node 110. This can arise when, for example, the consumer node is an individual or small organization while the sponsor node 110 is a larger, more established organization or a more reputable person. In order to support the consumer node 104, the sponsor node 110 may require the consumer node 104 to pay a fee for the sponsor node's support. With the support of the sponsor node 110, the consumer node 104 likely has more leverage in business transactions and, as a result, will likely be trusted more easily by a provider node 108. The same applies to the relationship between the provider node 108 and the promoter node 116—a fee (or service) may be required to establish the relationship with the promoter node 116.

After these relationships are established, the sponsor node 110 communicates with the promoter node 116 to establish a relationship. In one embodiment, the relationship is established via a contractual agreement between the two parties. Such an agreement encompasses business collaboration specification to underwrite forthcoming contractual agreements in between consumers and providers that the sponsor and the promoter support respectively. The establishment of the relationship (i.e., the terms of the contractual agreement) between the sponsor node 110 and the promoter node 116 relies on an establishment of trust between the two parties. This establishment of trust may be based on, for example, the reputation of each party. For example, each supporting node 110, 116 may be a large organization with a positive business reputation. The trust relationship established between the two supporting nodes 110, 116 may be based on their reputation in the business community, their size, people in the organization, or any other factor or combination of factors.

The relationship between the two supporting nodes 110, 116 may be created dynamically. As used herein, a dynamic agreement is an agreement whose terms can be set or adjusted based on one or more factors. Moreover, an agreement created dynamically is created at the time that an agreement is needed (e.g., after a request is received) rather than at an earlier time (i.e., a static agreement created before a request is received). For example and as described in more detail below, suppose the consumer node 104 communicates with the sponsor node 110 to request a service provided by the provider node 108. The sponsor node 110 may communicate this request to the promoter node 116. The promoter node 116 may establish a relationship with the sponsor node 110 (shown with line 120) based on whether the sponsor node 110 is on a list stored by the promoter node 116. This list may include ratings of different companies. Each company's ratings may be associated with the company's reputation. Thus, if the sponsor node 110 has an exceptionally good reputation, their reputation may correspond to an exceptionally high rating in the promoter node's list. Further, the sponsor node's position on the list and/or rating may change over a period of time.

This dynamic establishment of a relationship and, therefore, trust, between the two supporting nodes 110, 116 then enables communications (i.e., trust) to be established between the consumer node 104 and the provider node 108 (as shown with line 122). The establishment of trust between the consumer and the provider is based on the “chain of trust” across the static trust between the consumer and the sponsor, the dynamically established trust between the sponsor and the promoter, and the static trust between the promoter and the provider. The establishment of a business relationship between the consumer and the provider is based on a dynamically established agreement between the two parties. The agreement may have terms that are set or adjusted as a result of the relationship between the two supporting nodes 110, 116.

In one embodiment, the sponsor node 110 and the promoter node 116 establish partial trust with the consumer node 104 and the provider node 108, respectively. Partial trust as used herein refers to when one party does not trust another party completely but rather trusts the party only to a specified degree (e.g., a specified monetary amount). For example, a sponsor node 110 may request a consumer's credit limit on a particular credit card during the trust relationship establishment. The sponsor node 110 may then only trust the consumer 104 up to the consumer's credit limit. Thus, if a consumer 104 has a credit limit of $500, then the sponsor node 110 will only vouch for the consumer 104 for transactions of less than or equal to $500. Similarly, the promoter node 116 may establish partial trust with the provider node 108. For example, the promoter node 116 can support the provider node 108 for services that cost no more than some predetermined amount. The predetermined amount may also change as the provider node 108 gains a reputation for providing services to customers. As the provider node 108 continues to successfully provide services to consumers, the promoter node 116 will likely become more comfortable supporting the provider node 108 and the predetermined amount may increase.

The invention provides many benefits. As the resources (e.g., processing power, memory, battery life, and communications bandwidth) of the consumer node 104 and the provider node 108 may be limited relative to the sponsor node 110 and the promoter node 116, trust delegation to the sponsor node 110 and the promoter node 116 facilitates trust establishment between a consumer node 104 and a provider node 108. Further, the trust delegation architecture enhances scalability because once the business-level trust between the sponsor and promoter is established, the construction of consumer-provider trust can occur via the chain of consumer-sponsor-promoter-provider trust. Also, dynamic trust between reputable parties (i.e., sponsors and promoters) can typically be built much more easily and much stronger than trust between unknown parties. Specifically, it is generally expected that sponsors and promoters remain in the market for a much longer period of time than consumers and providers. This leads to a much stronger and more easily established trust relationship between sponsors and promoters.

Additionally, the dynamic trust architecture 100 enables any party to be a sponsor and/or a promoter and does not rely on a single, centralized server. Unlike the centralized server approach, which typically provides complete trust to the party being supported, the supporting nodes 110, 116 in the dynamic trust architecture 100 provide partial trust to the consumer node 104 and the provider node 108. As described above, this partial trust can be based on a variety of factors, such as past dealings with the consumer or provider, reputation of the party, etc.

Further, each sponsor node 110 and promoter node 116 can support multiple consumer and provider nodes respectively.

Last, but not least, the static trust arrangements of consumer and sponsor nodes and of provider and promoter nodes, and the dynamic trust arrangements of sponsor and promoter nodes enable “open” and spontaneous service interactions between consumer and provider nodes across different trust domains. This effectively eliminates the limitation (i.e., the market segmentation) of the centralized trust architecture.

As an example of the dynamic trust architecture, suppose a consumer is interested in viewing a particular video clip on his mobile telephone (i.e., consumer node 104). The consumer has a subscription with a first mobile operator (i.e., sponsor node 110). The consumer uses a discovery service to locate the particular video clip on the web. The service provider of the video clip (i.e., provider node 108) has business affiliation with a second mobile operator (i.e., promoter node 116). The consumer checks for the credibility of the provider via a credibility service provided by the first mobile operator (i.e., sponsor node 110). The first mobile operator then checks the credibility of the second mobile operator (i.e., promoter node 116). The second mobile operator (i.e., promoter node 116) partially trusts the provider (i.e., provider node 108) and vouches for the provider for up to a predetermined amount (e.g., $5 per transaction). This vouch limit is the second mobile operator's business decision and may be based on the business agreement with the provider and the credibility information, such as transaction history, about the provider. The first mobile operator (i.e., sponsor node 110) makes a similar business decision based on the vouch amount from the second mobile operator (promoter node 116), and credibility information about the second mobile operator, and provides a particular vouch limit (e.g., up to $2 per transaction) to the consumer. The vouch amount from the first mobile operator and from the second mobile operator reflect risk factors associated with the provider and the second mobile operator, respectively.

The consumer then uses the consumer node 104 to send a service request to the provider node 108 for the particular video clip. The provider offers the service for $1.00. In one embodiment, service information about the video clip, such as time duration and quality, is also delivered to the consumer. The consumer uses this information to determine whether the consumer is going to purchase the service. The consumer feels comfortable with the transaction because, in any case of fraud and/or dissatisfaction (within the limit of predefined terms and conditions), he can get full refund (i.e., $1) from the sponsor as the sponsor vouches for the service up to $2. After the consumer agrees to the terms and conditions of the service (e.g., with an “I Agree” button on a web page), the provider then verifies the credibility of the consumer through the second mobile operator (i.e., promoter node 116). Once the provider is satisfied with the credibility of the consumer for payment, the provider carries out the transaction by delivering the service and the consumer pays the provider for the service.

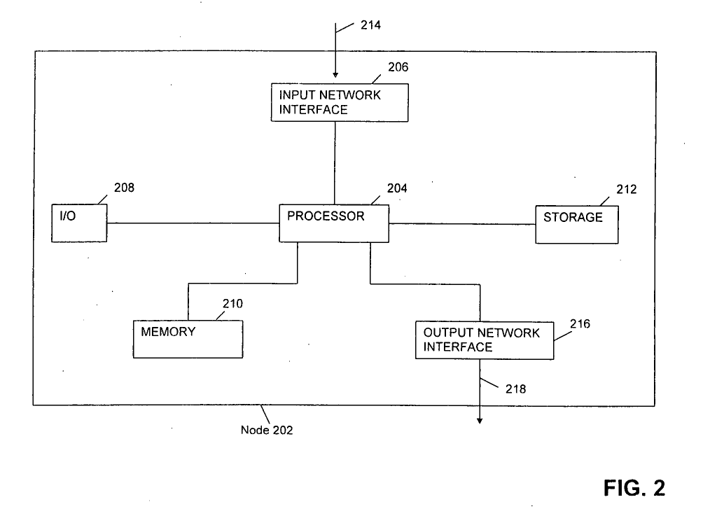

FIG. 2 shows a high level block diagram of a computer implementation of a node (e.g., consumer node, provider node, sponsor node, or promoter node) of the dynamic trust architecture 100. Node 202 contains a processor 204 which controls the overall operation of the computer by executing computer program instructions which define such operation. The computer program instructions may be stored in a storage device 212 (e.g., magnetic disk, database) and loaded into memory 210 when execution of the computer program instructions is desired. Thus, the node's operation will be defined by computer program instructions stored in memory 210 and/or storage 212 and the computer will be controlled by processor 204 executing the computer program instructions. Node 202 also includes one or more input network interfaces 206 for receiving communications from other devices via a network (e.g., the Internet). Node 202 also includes one or more output network interfaces 216 for transmitting communications 218 to other devices. In one embodiment, the input and output network interfaces 206, 216 are incorporated into a single network interface. Node 202 also includes input/output 208 which represents devices which allow for user interaction with the computer 202 (e.g., display, keyboard, mouse, speakers, buttons, etc.). One skilled in the art will recognize that an implementation of an actual computer will contain other components as well, and that FIG. 2 is a high level representation of some of the components of such a computer for illustrative purposes. Further, the components and functions described above can also be implemented in one or more software modules.

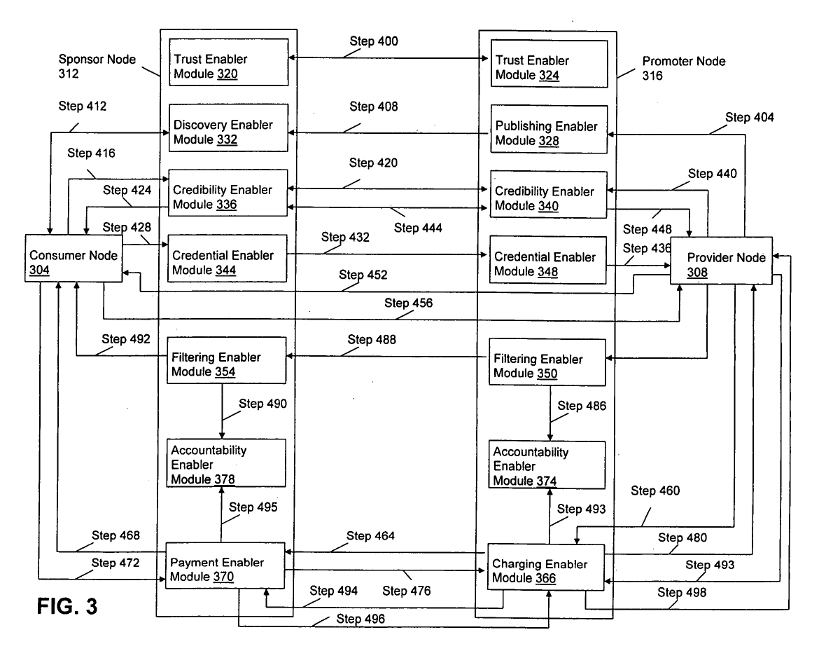

FIG. 3 shows a more detailed block diagram of the dynamic trust architecture and the communications between the nodes. Consumer node 304 is a consumer of a service provided by provider node 308. In order to establish trust between the consumer node 304 and the provider node 308, a pre-existing relationship between the consumer node 304 and sponsor node 312 is assumed. Similarly, a pre-existing relationship between the provider node 308 and promoter node 316 is assumed.

The sponsor node 312 first establishes a relationship with the promoter node 316 in step 400. As described above, this relationship is dynamically established. Trust between the sponsor node 312 and the promoter node 316 may be based on a dynamically established contractual agreement and reputation. An example of the sponsor node 312 is a node of a large internet service provider (ISP). An example of the promoter node 316 is a node of a large telephone service provider. Both of these organizations have long-standing business reputations and are likely trustworthy based on these reputations. This relationship is dynamically established but may alternatively be a static, pre-established relationship.

In one embodiment, each node 312, 316 has a respective trust enabler module 320, 324. Each trust enabler module 320, 324 communicates messages to establish a relationship between the sponsor node 312 and the promoter node 316.

The provider node 308 then registers a service with the promoter node 316 in step 404. For example, the promoter node 316 includes a publishing enabler module 328 that publishes services registered with the promoter node 316 on the web. The publication of services on the web may include transmitting the registered services to a web server that publishes web services.

The sponsor node 312 includes a discovery enabler module 332. The discovery enabler module 332 is a module that can view the services that are published by the publishing enabler module 328 in step 408. In one embodiment, the discovery enabler module 332 retrieves a notification that a new service has been published on the web by the publishing enabler module 328 each time a new service is published. Alternatively, the discovery enabler module 332 checks with the publishing enabler module 328 periodically or on-demand to determine what services are currently available.

In one embodiment, the consumer node 304 transmits a request to the discovery enabler module 332 to request a published service offered by the provider node 308 in step 412. In one embodiment, the consumer node 304 retrieves (i.e., pulls) a listing of services offered by the provider node 308 from the discovery enabler module 332. In another embodiment, the discovery enabler module 332 transmits (i.e., pushes) a listing of services offered by the provider node 308 to the consumer node 304. The consumer reviews the offered services to determine if the consumer would like to purchase a published service.

Once the consumer finds a service that the consumer would like to use (e.g., display) on the consumer node 304 (e.g., on the consumer's wireless telephone), the consumer then has to feel comfortable purchasing the service from a provider node 308 whose trustworthiness the consumer likely knows nothing about. To increase the level of trust between the consumer and provider, the consumer uses the consumer node 304 to request a credibility report about the provider from the sponsor node 312 in step 416. The consumer node 304 transmits the request for a credibility report to a credibility enabler module 336. The credibility enabler module 336 forwards the request to a credibility enabler module 340 of the promoter node 316 in step 420. In one embodiment, because of the pre-existing relationship between the promoter node 316 and the provider node 308, the promoter node 316 does not request a credibility report from the provider node 308. Instead, the promoter node 316 transmits a credibility message to the sponsor node 312 attesting to the credibility of the provider node 308 in step 420. The credibility enabler module 336 forwards the message to the consumer node 304 in step 424 and the consumer node 304 reviews the message. The credibility report can be, for example, in the form of a vouch limit (e.g., the sponsor node can vouch for the provider for up to $2 for a particular transaction).

After the consumer receives the credibility report associated with the provider, the consumer then transmits a request for the service in step 428. A credential enabler module 344 receives the request and transmits the service request to a credential enabler module 348 on the promoter node 316 in step 432. The credential enabler module 348 forwards the request to the provider node 308 in step 436. Each respective credential enabler module 344, 348 is a security component providing consumer identity credentials for authentication, authorization and accounting purposes. In one embodiment, the credential enabler module provides privacy protection to the consumer node 304 and non-repudiation protection (for a service contract) to the provider node 308, respectively. In particular, the credential enabler modules 344, 348 can use a variety of authentication technologies such as user ID, fingerprint, retina scan, etc.

Once the provider node 308 receives a service request, the provider node 308 checks the consumer's credibility by transmitting a request to the credibility enabler module 340 in step 440. The credibility enabler module 340 forwards the request to the sponsor node 312 in step 444. The sponsor node 312 verifies the credibility of the consumer node 304 (e.g., by transmitting a verification message back to the promoter node 316). The promoter node 316 forwards the message to the provider node 308 in step 448. Once the provider node 308 receives a credibility report about the consumer back and is satisfied with the report, the provider node 308 is ready to begin transmitting the service to the consumer node 304.

The provider node 308 first transmits the service terms and conditions to the consumer node 304 in step 452. The service terms and conditions include, for example, how the service can be used, if the service can be copied or distributed, etc. The provider node 308 does not deliver the service to the consumer node 304 until the provider node 308 receives an acceptance message from the consumer node 304 accepting the service terms and conditions in step 456. In one embodiment, the service terms and conditions are presented to the consumer node 304 as a web page with a click button at the end of the page. By clicking the button, the consumer is accepting the terms and conditions.

After receiving the acceptance, the provider node 308 reserves funds in a charging enabler module 366 in step 460. The charging enabler module 366 then communicates a reservation message to a payment enabler module 370 of the sponsor node 312 to request the required funds for the service in step 464. The payment enabler module 370 communicates an indication of the charge to the consumer node 304 in step 468 and the consumer node then sends a message back to the payment enabler module 370 confirming the charge in step 472. The payment enabler module 370 transmits a fund reserve message in step 476 to the charging enabler module 366 and the charging enabler module 366 transmits a reservation indication to the provider node 308 in step 480.

The provider node 308 then transmits, in step 484, the service (i.e., service file(s)) to the promoter node 316. In more detail, the provider node 308 transmits the service file(s) to the consumer through a filtering enabler module 350 in the sponsor node and a filtering enabler module 354 in the promoter node. The filtering enabler module 350 filters the service file(s) for any malicious or inappropriate content. In one embodiment, the filtering enabler module 350 begins logging the results of the filtering in step 486. Thus, the filtering enabler module 350 can log information if a particular file is infected with a virus or is corrupt.

After filtering the service file(s), the filtering enabler module 350 transmits the service file(s) to the filtering enabler module 354 of the sponsor node 312 in step 488. This filtering enabler module 354 may filter the service file(s) using different criteria relative to the filtering performed by the filtering enabler module 350. The filtering enabler module 354 can then log the results of the filtering in step 490. The filtering enabler module 354 then delivers the service to the consumer node 304 in step 492.

The provider node 308 then issues a charge to the charging enabler module 366 for the provided service in step 493. The charging enabler module 366 checks the accountability of the charge from the provider node 308 by communicating with an accountability enabler module 374 in step 493. The accountability enabler module 374 is a security component that delivers non-repudiation protection for service delivery to the provider node 308 via the logged information about the delivery of the service with the help of the filtering enabler module in step 486.

Once the accountability check is completed, the charging enabler module 366 transmits a debit request to the payment enabler module 370 in step 494. The payment enabler module 370 performs an accountability check on the charge from the provider node 308 by communicating with an accountability enabler module 378 in step 495. The accountability enabler module 378 is a security component that delivers fraud protection to the consumer. The logged information about the delivery of the service with the help of the filtering enabler module in step 490 provides necessary information.

The payment enabler module 370 then transmits the funds associated with the service to the charging enabler module 366 in step 496. The charging enabler module 366 transmits an indication that the funds have been received to the provider node 308 in step 498. The payment by the consumer node 304 may occur via an on-line credit card payment form in which the consumer enters his or her credit card information into a form accessed over the network. The form returns a confirmation when the consumer's credit card information has been verified as being legitimate. For protection of consumer's privacy and information theft, delivering credit card information all the way to the provider may not be desirable, but rather employing different methods for payment may be recommended.

It should be noted that one or more of the modules described above may be combined into any number of modules. Moreover, one or more of the functions described above may be implemented by any module or modules.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for establishing communications between a first node and a second node to enable interaction to occur over a network, said first node having a pre-established trust relationship with a first supporting node and said second node having a pre-established trust relationship with a second supporting node, the method comprising:
establishing a trust relationship between said first node and said second node, said trust relationship based on a trust relationship between said first supporting node and said second supporting node.

2. The method of claim 1 wherein said interaction between said first node and said second node is an e-commerce transaction.

3. The method of claim 1 wherein said establishing of said trust relationship between said first node and said second node further comprises establishing said first supporting node as being responsible for communications made from said first node.

4. The method of claim 1 further comprising receiving a request from said first node to establish said trust relationship with said second node.

5. The method of claim 4 wherein said trust relationship between said first supporting node and said second supporting node is dynamically established after or before said request is received.

6. The method of claim 1 further comprising receiving a request from said first node for a service provided by said second node.

7. The method of claim 6 further comprising delivering said service to said first node in response to said request.

8. The method of claim 1 wherein said pre-established trust relationship between said first node and said first supporting node is partial.

9. The method of claim 1 wherein said pre-established trust relationship between said second node and said second supporting node is partial.

10. The method of claim 8 wherein said partial trust is measured via a currency value.

11. The method of claim 9 wherein said partial trust is measured via a currency value.

12. A system comprising:
a first supporting node having a pre-existing trust relationship with a first node;
a second supporting node having a pre-existing trust relationship with a second node;
wherein a trust relationship is established over a network between said first node and said second node based on a dynamic trust relationship between said first supporting node and said second supporting node.

13. The system of claim 12 wherein said first supporting node further comprises a trust enabler module to establish said dynamic trust relationship with said second supporting node.

14. The system of claim 12 wherein said second supporting node further comprises a publishing enabler module to publish services available from said second node on said network.

15. The system of claim 14 wherein said first supporting node further comprises a discovery enabler module to view said published services.

16. The system of claim 12 wherein said first supporting node further comprises a credibility enabler module for checking credibility of said second node.

17. The system of claim 12 wherein said first supporting node further comprises a credential enabler module for forwarding a service request from said first node to a second node via a second supporting node.

18. The system of claim 12 wherein said first supporting node further comprises an accountability enabler module for making said first supporting node responsible for ensuring delivery of and quality of a service sent from said second node to said first node.

19. The system of claim 12 wherein said second supporting node further comprises a filtering enabler module for collecting information for delivery of a service from said second node to said first node.

20. The system of claim 12 wherein said first supporting node further comprises a payment enabler module for receiving payment from said first node.

21. A system for establishing communications between a first node and a second node to enable interaction to occur over a network, said first node having a pre-established trust relationship with a first supporting node and said second node having a pre-established trust relationship with a second supporting node, the system comprising:
means for establishing a trust relationship between said first node and said second node, said trust relationship based on a trust relationship between said first supporting node and said second supporting node.

22. The system of claim 21 wherein said interaction between said first node and said second node is an e-commerce transaction.

23. The system of claim 21 wherein said means for establishing said trust relationship between said first node and said second node further comprises means for authenticating said first node.

24. The system of claim 21 wherein said means for establishing said trust relationship between said first node and said second node further comprises means for authorizing said first node to communicate with said second node.

25. The system of claim 21 wherein said means for establishing said trust relationship between said first node and said second node further comprises means for establishing said first supporting node as being responsible for communications made from said first node.

26. The system of claim 21 further comprising means for receiving a request from said first node to establish said trust relationship with said second node.

27. The system of claim 26 wherein said trust relationship between said first supporting node and said second supporting node is dynamically established after or before said request is received.

28. The system of claim 21 further comprising means for receiving a request from said first node for a service provided by said second node.

29. The system of claim 28 further comprising means for delivering said service to said first node in response to said request.

30. The system of claim 21 wherein said pre-established trust relationship between said first node and said first supporting node is partial.

31. The system of claim 21 wherein said pre-established trust relationship between said second node and said second supporting node is partial.
